(19) United States
(12) Patent Application Publication
(10) Pub. No.: US 2009/0165603 A1
(43) Pub. Date: Jul. 2, 2009

(54) Pliers device for changing light bulb in physically constrained location

(76) Inventor: Tito Aguirre, Independence, OR (US)

Correspondence Address: STEVEN J. ADAMSON, PC, P.O. BOX 5997, PORTLAND, OR, 97228, US

(21) Appl. No.: 12/231,188

(22) Filed: Aug. 29, 2008

Related U.S. Application Data
(60) Provisional application No. 60/967,143, filed on Aug. 31, 2007.

(51) Int. Cl. B25B 7/02

(52) U.S. Cl. 81/426.5

(57) ABSTRACT

A light bulb holding pliers device having movably coupled longitudinal members. A handle region may be provided at one end of the longitudinal members and a bulb gripping or holding structure may be provided at the other end. The holding structure may include a frame having at least three points of contact and a compressive material may extend inwardly of a frame, towards the other frame. A releasable locking mechanism permits the device to be clamped to a light bulb to hold it securely without breaking it. The device of the present invention is particularly useful in changing light bulbs in constrained areas, such a motor vehicle dashboards and the like. The longitudinal member may be long and narrow to facilitate this task.

### CROSS REFERENCE TO RELATED APPLICATIONS

This application claims the benefit of U.S. Provisional Application No. 60/967,143, filed Aug. 31, 2007, entitled “Plier Device for Changing Light Bulb in Physically Constrained Location” and having the same inventor as above.

### FIELD OF THE INVENTION

The present invention relates to pliers that are specially configured to hold and lock a light bulb, yet supple enough to securely hold the light bulb without breaking it. The present invention is well suited for use in changing light bulbs in hard to access locations such as vehicle dashboards.

### BACKGROUND OF THE INVENTION

The prior art includes mechanisms for changing light bulbs located in elevated locations, for example, gymnasium, church and stair well ceilings, etc. These devices tend to be “finger” devices that include a plurality of mechanical fingers located on one end of a pole and an actuator, linked to the fingers, that is located on the operator end of the pole.

The prior art also includes many different types of pliers devices. In general, these devices are not related to light bulb changing, but rather a given mechanical task such as loosening or tightening a nut or bolt. While some of these devices may have a locking function, such as vice grips, the gripping ends are too hard and inflexible for use with glass and will readily break a light bulb.

Hemostats and surgical clamps are devices that also have a locking function, often imparted by the flexible metal material of which the devices are made, permitting a releasable latching at the handle end. Hemostats and surgical clamp structures, however, have not been applied to light bulb changing and related arts. Furthermore, hemostats and surgical clamps tend to taper at their gripping end and do not provide sufficient structure to gently and securely hold a light bulb.

A problem exists related to changing light bulbs in vehicle dashboards or other highly constrained locations. Often the bulbs are small and located in areas too small for a human hand to reach. When it is necessary or desired to change a bulb, a mechanic must remove several layers of the dashboard, requiring a significant amount of shop time to remove and reinstall those layers. Through use of the present invention, a mechanic may access a bulb without removing multiple layers of the dashboard, resulting in more rapid bulb changing and significant cost savings. This also leads to better and safer vehicle operation because the reduced cost of replacement leads to more frequent replacement of burned out lights.

### SUMMARY OF THE INVENTION

Accordingly, it is an object of the present invention to provide locking pliers or grips that permit secure yet sufficiently delicate holding and locking to a light bulb.

A pair of pliers or grips in accordance with the present invention may be formed of metal, such as steel or other suitable material that is sufficiently rigid and durable, yet provides some degree of flexibility to permit tension and the holding of a bulb under bias.

The bulb end preferably includes a distributed frame and soft, non-slip material for holding a bulb, while the handle end may include a releasable locking mechanism.

These and related objects of the present invention are achieved by use of a pliers device for changing a light bulb in physically constrained location as described herein.

The attainment of the foregoing and related advantages and features of the invention should be more readily apparent to those skilled in the art, after review of the following more detailed description of the invention taken together with the drawings.

### BRIEF DESCRIPTION OF THE DRAWINGS

FIGS. 1-2 are plan views of a light bulb pliers device, without and with a light bulb, respectively, in accordance with the present invention.

FIG. 3 is a sectional plan view of the handle region of the device of FIG. 1.

FIGS. 4A-4B are side elevation views of the holding or bulb end of the device of FIG. 1.

### DETAILED DESCRIPTION

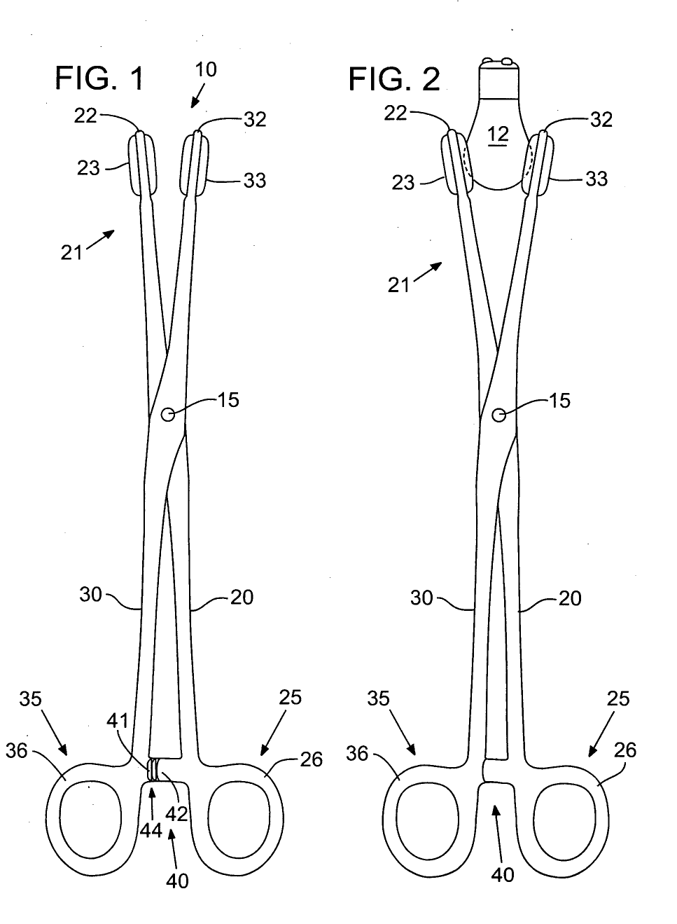

Referring to FIGS. 1-2, plan views of a light bulb pliers device 10, without and with a light bulb, in accordance with the present invention are respectively shown.

Device 10 may include first and second longitudinal members 20,30 that are moveably coupled to one another at pivot 15. At the holding or bulb end 21,31, each of the first and second members may have a frame 22,32, oval or circular or otherwise shaped, that extends therefrom and holds a non-slip grommet or pad 23,33 preferably made of rubber or other suitably soft, elastic and/or non-slip material. Frame 22,32 and pads 23,33 serve to more evenly distribute the holding force to a bulb.

Frames 22,32 may have a substantially planar configuration and be disposed in a plane substantially perpendicular to the plane in which longitudinal members 20,30 pivotally move. While frames 22,32 are shown as rings (for example, in FIGS. 4A-4B), it should be recognized that the frames may be configured to have at least three contact points that are distributed in a common plane and arranged to provide adequate support to a bulb.

At the handle-end 25,35, finger loops or other finger receiving structures 26,36 may be provided. A releasable locking device 40 may be provided at the handle end 25,35 to permit compressive pads 23,33 to be closed about bulb 12 and locked into a secure holding position.

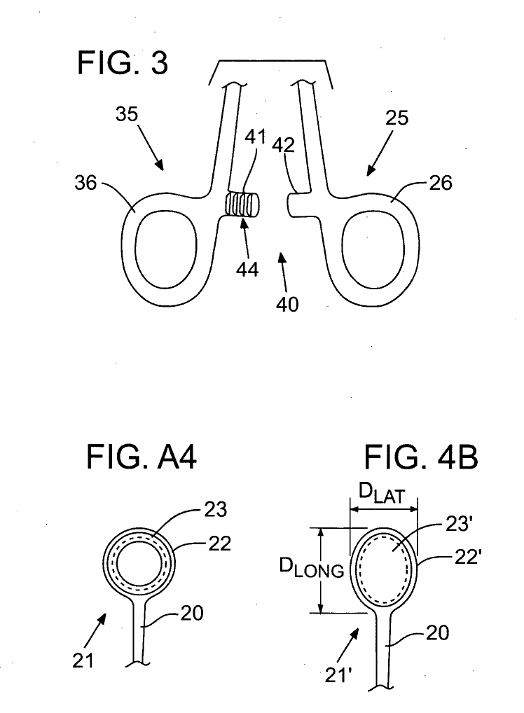

The releasable locking mechanism 40 may include two oppositely disposed members 41,42 each with a plurality of facing, angled teeth 44. FIG. 3 illustrates teeth 44 on member 41. A similar arrangement is preferably provided on member 42, though member 42 could include a single tooth for latching to the teeth on member 41, or another latching arrangement. The teeth may be moved into engagement with each other and secured at a plurality of different positions, depending on whether a light bulb is present and, if so, the size of the light bulb.

The longitudinal member 20,30 and the releasable locking mechanism 40 may be fabricated in a manner similar to that in a hemostat, with the longitudinal members being made of a suitably flexible metal (or other material) to impart a bias onto the mating parts of the locking mechanism, causing them to remain clasped. While metal is a preferred material, it should be recognized that the longitudinal members may be made of plastic or another suitably durable, steadfast, yet flexible material. It should also be recognized that other locking mechanisms, such as a pivoting latch with different latch settings or another arrangement could be used.

The handle region 25,35 may be covered in a natural or synthetic rubber coating or plastic or other material and/or shape configuration that facilitates ready holding and operation by a user.

Referring to FIG. 3, a sectional plan view of the handle section of device 10 of FIG. 1 is shown. FIG. 3 illustrates handle ends 25,35 open such that all the rows of teeth 44 on member 41 are visible. The non-visible side of member 42 may be similarly configured, or have a single tooth that latches to teeth 44.

Referring to FIGS. 4A-4B, side elevation views of the holding or bulb end of pliers device 10 in accordance with the present invention are shown. While frame 22 is shown, it should be recognized that frame 32 may be made in a similar manner. FIG. 4A illustrates a circular frame 22 and a correspondingly shaped grommet 23, while FIG. 4B illustrates an oval frame 22′ and a correspondingly shaped pad 23′. The shape of the frame and grommet/pad may correspond to the shape of the light bulb to be held by the pliers, though the frames may be otherwise configured. A “universal fit” configuration may be utilized that includes an oval or other shape.

In the embodiment of FIG. 4B, the frame has a principal longitudinal dimension, D_{LONG}, and a principal lateral dimension, D_{LAT}. (Note that D_{LONG} and D_{LAT} are rotated 90 degrees if the oval is rotated that amount; D_{LONG} is not necessarily an extension of the longitudinal member.) Except in the case of some unusually shaped light bulbs, D_{LONG} will typically be about or less than two times D_{LAT}. Of course, these dimensions are equal in a circular frame. Note that the frame may be square, rectangular, triangular or otherwise shaped.

Grommet 23 may be a ring, open in the center as depicted in FIG. 4A. Alternatively, pad 23′ may have substantially continuous material at the center, i.e., not open in the center as depicted in FIG. 4B. The grommet and pad are preferably made of a compressive, elastic and non-slip material to safely and secure hold a bulb. Suitable materials include rubber and rubber like materials. If the frame is made of plastic then the pliers device could be made without a softer, gripping grommet or pad, though use of such a grommet or pad is preferred for proper operation.

Pliers device 10 is preferably formed by creating a mold for each longitudinal member and associated frame and handle and pouring the appropriate molten metal material, such as that used in conventional hemostats, or other suitable material into the mold. Next, those parts are cleaned, polished and machined as necessary. Then, the grommets 23,33 or the like and the handle coatings, if any, are added, after which the longitudinal members are joined at pivot 15 to complete the device.

While the invention has been described in connection with specific embodiments thereof, it will be understood that it is capable of further modification, and this application is intended to cover any variations, uses, or adaptations of the invention following, in general, the principles of the invention and including such departures from the present disclosure as come within known or customary practice in the art to which the invention pertains and as may be applied to the essential features hereinbefore set forth, and as fall within the scope of the invention and the limits of the appended claims.

1. A light bulb holding pliers device, comprising:
first and second longitudinal members, each including a holding end and a handle end, that are pivotally coupled to one another such that movement of the respective handle ends achieves a corresponding movement in the respective holding ends;
first and second bulb supporting frames respectively extending from the first and second longitudinal members at their holding ends, each frame having at least three contact points in a common plane, the contact points defining a geometric shape that has a primary longitudinal dimension that is approximately equal to or less than two times its primary lateral dimension, and wherein the common planes defined by the first and second frames are substantially perpendicular to a plane in which the first and second longitudinal members pivotally move; and
a releasable latching mechanism;
wherein at least one of the longitudinal members includes a material having sufficiently elastic properties that the latching mechanism is maintained in a latched position due to the bias force imparted by the elastic properties of that longitudinal member.

2. The device of claim 1, further comprising elastic and substantially non-slip material coupled to at least one of the first and second frames.

3. The device of claim 2, wherein the elastic and substantially non-slip material is rubber.

4. The device of claim 1, wherein the longitudinal member having sufficiently elastic properties is made of metal.

5. The device of claim 1, wherein the frames are substantially planar in shape and disposed in a plane that is substantially perpendicular to that in which the longitudinal members move.

6. The device of claim 1, wherein the frames have a central opening.

7. The device of claim 1, wherein the frames are one of circular and oval in shape.

8. The device of claim 7, further comprising a compressive material coupled to each frame that is configured as one of a ring grommet and a substantially continuous pad.

9. The device of claim 1, wherein the latching mechanism includes first and second interlocking members that respectively extend from the handle ends of the first and second longitudinal members.

10. A light bulb holding pliers device, comprising:
first and second longitudinal members, each including a holding end and a handle end, that are pivotally coupled to one another such that movement of the respective handle ends achieves a corresponding movement in the respective holding ends;
first and second bulb supporting frames respectively extending from the first and second longitudinal members at their holding ends;
compressive material coupled to each of the first and second frames and disposed inwardly, toward the other of the first and second frames; and
a releasable latching mechanism;
wherein at least one of the longitudinal members includes a material having sufficiently elastic properties that the latching mechanism is maintained in a latched position due to the bias force imparted by the elastic properties of that longitudinal member.

11. The device of claim 10, wherein the compressive material is an elastic and substantially non-slip material.

12. The device of claim 10, wherein the longitudinal member having sufficiently elastic properties is made of metal.

13. The device of claim 10, wherein each frame has at least three contact points in a common plane, the contact points defining a geometric shape that has a primary longitudinal dimension that is approximately equal to or less than two times its primary lateral dimension, and wherein the common planes defined by the first and second frames are substantially perpendicular to a plane in which the first and second longitudinal members pivotally move.

14. The device of claim 10, wherein the frames are configured to define a central opening.

15. The device of claim 14, wherein the compressive material is configured as one of a ring grommet and a substantially continuous pad.

16. A light bulb holding pliers device, comprising:
first and second longitudinal members, each including a holding end and a handle end, that are pivotally coupled to one another such that movement of the respective handle ends achieves a corresponding movement in the respective holding ends;
first and second bulb supporting frames respectively extending from the first and second longitudinal members at their holding ends, each frame having at least three contact points in a common plane; and
a releasable latching mechanism for releasably holding a light bulb between the frames;
wherein each frame is configured to define an opening between its contact points.

17. The device of claim 16, further comprising compressive material coupled to each frame and disposed substantially inwardly towards the other frame.

18. The device of claim 16, wherein the contact points of each frame define a geometric shape that has a primary longitudinal dimension that is approximately equal to or less than two times its primary lateral dimension.

19. The device of claim 16, wherein each of the common planes is aligned substantially perpendicular to a plane in which the first and second longitudinal members pivotally move.

20. The device of claim 16, wherein at least one of the longitudinal members includes a material having sufficiently elastic properties that the latching mechanism is maintained in a latched position due to the bias force imparted by the elastic properties of that longitudinal member.
